(19) United States
(12) Patent Application Publication
(10) Pub. No.: US 2011/0032713 A1
(43) Pub. Date: Feb. 10, 2011

(54) LIGHTING ASSEMBLY

(76) Inventor: Nicholas Peter Okun Miron, Greenwich, CT (US)

Correspondence Address: HOLLAND & KNIGHT LLP, 10 ST. JAMES AVENUE, BOSTON, MA, 02116-3889, US

(21) Appl. No.: 12/536,822

(22) Filed: Aug. 6, 2009

(51) Int. Cl. B60Q 1/00; F21V 15/00

(52) U.S. Cl. 362/370; 362/362

(57) ABSTRACT

A lighting assembly including a body assembly configured to allow for the passage of visible light, the body assembly including a socket assembly configured to removable receive a cap assembly of a bulb assembly. A bulb recess is configured to receive at least a portion of the bulb assembly, such that the bulb recess is configured to form a shroud that visually obscures at least a portion of a light emitting portion of the bulb assembly. A conductor assembly is configured to provide electrical energy to the socket assembly.

### TECHNICAL FIELD

This disclosure relates to lighting assemblies and, more particularly, to cast lighting assemblies.

### BACKGROUND

Lighting assemblies provide light to their users. Lighting assembly may be suspended from ceilings, included within ceilings, mounted to walls, placed upon tables, or used outdoors to provide accent lighting.

Unfortunately, such systems are often devoid of visual intrigue and do not provide a high level of excitement to their users. While assemblies may be adorned with various accessories to obtain visual appeal, their design often appears cluttered.

### SUMMARY OF DISCLOSURE

In a first implementation, a lighting assembly including a body assembly configured to allow for the passage of visible light, the body assembly including a socket assembly configured to removable receive a cap assembly of a bulb assembly. A bulb recess is configured to receive at least a portion of the bulb assembly, such that the bulb recess is configured to form a shroud that visually obscures at least a portion of a light emitting portion of the bulb assembly. A conductor assembly is configured to provide electrical energy to the socket assembly.

One or more of the following features may be included. A bracket assembly may be coupled to the body assembly and may be configured to attach the light assembly to a wall. A base assembly may be coupled to the body assembly. A cord assembly may be electrically coupled to the conductor assembly, such that the cord assembly may include a plug assembly configured to releasably engage an electrical outlet. A connector assembly may be electrically coupled to the conductor assembly, such that the connector assembly may be configured to releasably engage an electrical circuit.

The body assembly may be constructed of a transparent material. The transparent material may be glass. The body assembly may be constructed of a translucent material. The socket assembly may be configured to removable receive a cap assembly of an incandescent bulb assembly. The socket assembly may be configured to removable receive a cap assembly of a compact fluorescent bulb assembly.

In another implementation, a lighting assembly includes a body assembly configured to allow for the passage of visible light, the body assembly including a socket assembly configured to removable receive a cap assembly of a bulb assembly. A bulb recess is configured to receive at least a portion of the bulb assembly, such that the bulb recess is configured to form a shroud that visually obscures at least a portion of a light emitting portion of the bulb assembly. A conductor assembly is configured to provide electrical energy to the socket assembly. A bracket assembly is coupled to the body assembly and configured to attach the light assembly to a wall. A connector assembly is electrically coupled to the conductor assembly, such that the connector assembly is configured to releasably engage an electrical circuit.

One or more of the following features may be included. The body assembly may be constructed of a transparent material. The transparent material may be glass. The body assembly may be constructed of a translucent material. The socket assembly may be configured to removable receive a cap assembly of an incandescent bulb assembly.

In another implementation, a lighting assembly includes a body assembly configured to allow for the passage of visible light, the body assembly including a socket assembly configured to removable receive a cap assembly of a bulb assembly. A bulb recess is configured to receive at least a portion of the bulb assembly, such that the bulb recess is configured to form a shroud that visually obscures at least a portion of a light emitting portion of the bulb assembly. A conductor assembly is configured to provide electrical energy to the socket assembly. A base assembly is coupled to the body assembly. A cord assembly is electrically coupled to the conductor assembly, such that the cord assembly includes a plug assembly configured to releasably engage an electrical outlet.

One or more of the following features may be included. The body assembly may be constructed of a transparent material. The transparent material may be glass. The body assembly may be constructed of a translucent material. The socket assembly may be configured to removable receive a cap assembly of an incandescent bulb assembly.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a wall-mounted lighting assembly; and

FIG. 2 is a diagrammatic view of lamp lighting assembly.

Like reference symbols in the various drawings indicate like elements.

### DETAILED DESCRIPTION OF THE PREFERRED EMBODIMENTS

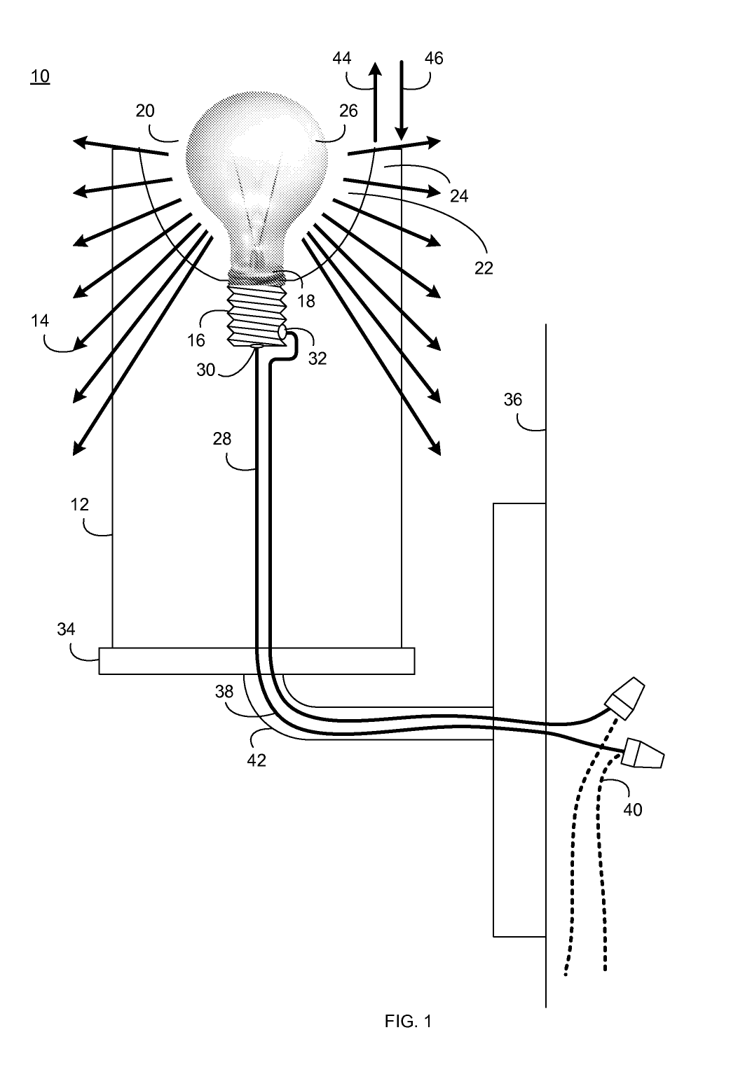

Referring to FIG. 1, there is shown lighting assembly 10 including a body assembly 12 configured to allow for the passage of visible light 14. Body assembly 12 may be constructed of a transparent material (e.g., clear glass, clear acrylic, and clear polycarbonate); or a translucent material (e.g., colored/etched glass, colored/etched acrylic, and colored/etched polycarbonate). Further, body assembly 12 may be constructed of a cast material (e.g., poured into a form and left to harden) or a machined material (e.g., machined from a solid block of material).

Body assembly 12 may include socket assembly 16 configured to removably receive cap assembly 18 of bulb assembly 20. Examples of bulb assembly 20 may include an incandescent bulb assembly and a compact fluorescent bulb assembly. Socket assembly 16 may be cast or machined into the body assembly 12. For example, if body assembly 12 is constructed of a cast material, socket assembly 16 may be cast into body assembly 12. Alternatively, if body assembly 12 is constructed of a machined material, socket assembly 16 may be machined into body assembly 12. Alternatively still, socket assembly 16 may be cast into body assembly 12 prior to machining body assembly 12 or socket assembly 16 may be machined into body assembly 12 after casting body assembly 12.

Socket assembly 16 may be constructed of a different material than body assembly 12, or may be integral with body assembly 12. For example, socket assembly 16 may be a threaded brass sleeve that is cast or machined into body assembly 12. Alternatively, socket assembly 16 may be formed by casting or machining threads into body assembly 12. Accordingly and in such an embodiment, socket assembly 16 may be integral with body assembly 12.

Body assembly 12 may include bulb recess 22 that is configured to receive at least a portion of bulb assembly 20, such that bulb recess 22 is configured to form shroud 24 that visually obscures at least a portion of light emitting portion 26 (e.g., the glass portion or fluorescent tube) of bulb assembly 20.

Body assembly 12 may include conductor assembly 28 that may be configured to provide electrical energy to socket assembly 16. Conductor assembly 28 may be cast or machined into body assembly 12. For example, if body assembly 12 is constructed of a cast material, conductor assembly 28 may be cast into body assembly 12. Alternatively, if body assembly 12 is constructed of a machined material, conductor assembly 28 may be machined into body assembly 12 (e.g., a hole may be drilled and conductor assembly 28 may be routed through the drilled hole). Alternatively still, conductor assembly 28 may be cast into body assembly 12 prior to machining body assembly 12 or conductor assembly 28 may be machined into body assembly 12 after casting body assembly 12.

Conductor assembly 28 may be constructed of any material capable of conducting electricity (e.g., ferrous metals and non-ferrous metals) in various configurations (e.g., insulated wire, uninsulated wire, and bar stock). Conductor assembly 28 typically includes a plurality of individual conductors for e.g., a line voltage conductor and a neutral conductor. One conductor may be electrically coupled to line voltage connector 30 of socket assembly 16 and the other conductor may be electrically coupled to neutral voltage connector 32 of socket assembly 16.

Lighting assembly 10 may include bracket assembly 34 coupled to body assembly 12 that may be configured to attach light assembly 10 to a wall (e.g., wall 36). Connector assembly 38 may be configured to electrically couple conductor assembly 28 to electrical circuit 40 included within wall 36. Connector assembly 36 may be rigidly coupled (e.g., soldered or electrically crimped) to conductor assembly 28 and may be releasably coupled (e.g., via wire nuts) to electrical circuit 40. In a typical embodiment, connector assembly 38 may be a pair of insulated wires. Alternatively, conductor assembly 28 and connector assembly 38 may be a single assembly that electrically couples socket assembly 16 to electrical circuit 40. In a typical embodiment, electrical circuit 40 may be a 14-2 non-metallic sheathed electrical cable. In a typical embodiment, bracket assembly 34 may include hollow tubular portion 42 through which connector assembly 36 may pass.

As discussed above, body assembly 12 may include bulb recess 22 that is configured to form shroud 24 that visually obscures at least a portion of light emitting portion 26 of bulb assembly 20. The height of shroud 24 may be adjusted to vary the level at which light emitting portion 26 of bulb assembly 20 is obscured. For example, shroud 24 may be lengthened (in the direction of arrow 44) to increase the level at which light emitting portion 26 of bulb assembly 20 is obscured. Alternatively, shroud 24 may be shortened (in the direction of arrow 46) to decrease the level at which light emitting portion 26 of bulb assembly 20 is obscured.

Shroud 24 may be configured as a shade assembly that completely surrounds (in the horizontal and/or vertical plane) light emitting portion 26 of bulb assembly 20. Alternatively, shroud 24 may only partially surround (in the horizontal and/or vertical plane) light emitting portion 26 of bulb assembly 20. Accordingly, instead of wrapping 360 degrees around light emitting portion 26 of bulb assembly 20, shroud 24 may only wrap e.g., 180 degrees around light emitting portion 26 of bulb assembly 20.

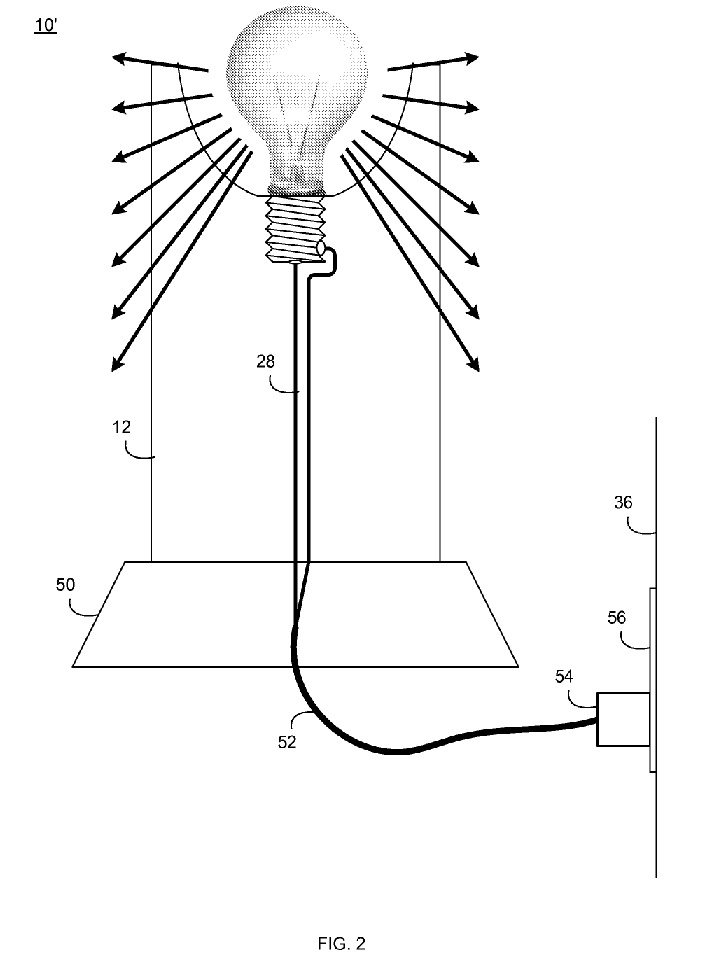

Instead of being configured as a wall-mounted lighting assembly (e.g., a sconce), lighting assembly 10 may be configured as a lamp assembly (e.g., a table lamp or a floor lamp). Referring also to FIG. 2, lighting assembly 10′ may be configured as a lamp assembly and may include base assembly 50 coupled to body assembly 12. Cord assembly 52 may be electrically coupled to conductor assembly 28 and may include plug assembly 54 configured to releasably engage electrical outlet 56 included within wall 36.

A number of implementations have been described. Nevertheless, it will be understood that various modifications may be made. Accordingly, other implementations are within the scope of the following claims.

What is claimed is:

1. A lighting assembly comprising:
a body assembly configured to allow for the passage of visible light, the body assembly including:
a socket assembly configured to removable receive a cap assembly of a bulb assembly,
a bulb recess configured to receive at least a portion of the bulb assembly, wherein the bulb recess is configured to form a shroud that visually obscures at least a portion of a light emitting portion of the bulb assembly, and
a conductor assembly configured to provide electrical energy to the socket assembly.

2. The lighting assembly of claim 1 further comprising:
a bracket assembly coupled to the body assembly and configured to attach the light assembly to a wall.

3. The lighting assembly of claim 1 further comprising:
a base assembly coupled to the body assembly.

4. The lighting assembly of claim 1 further comprising:
a cord assembly electrically coupled to the conductor assembly, wherein the cord assembly includes a plug assembly configured to releasably engage an electrical outlet.

5. The lighting assembly of claim 1 further comprising:
a connector assembly electrically coupled to the conductor assembly, wherein the connector assembly is configured to releasably engage an electrical circuit.

6. The lighting assembly of claim 1 wherein the body assembly is constructed of a transparent material.

7. The lighting assembly of claim 6 wherein the transparent material is glass.

8. The lighting assembly of claim 1 wherein the body assembly is constructed of a translucent material.

9. The lighting assembly of claim 1 wherein the socket assembly is configured to removable receive a cap assembly of an incandescent bulb assembly.

10. The lighting assembly of claim 1 wherein the socket assembly is configured to removable receive a cap assembly of a compact fluorescent bulb assembly.

11. A lighting assembly comprising:
a body assembly configured to allow for the passage of visible light, the body assembly including:
a socket assembly configured to removable receive a cap assembly of a bulb assembly,
a bulb recess configured to receive at least a portion of the bulb assembly, wherein the bulb recess is configured to form a shroud that visually obscures at least a portion of a light emitting portion of the bulb assembly, and
a conductor assembly configured to provide electrical energy to the socket assembly;
a bracket assembly coupled to the body assembly and configured to attach the light assembly to a wall; and
a connector assembly electrically coupled to the conductor assembly, wherein the connector assembly is configured to releasably engage an electrical circuit.

12. The lighting assembly of claim 11 wherein the body assembly is constructed of a transparent material.

13. The lighting assembly of claim 12 wherein the transparent material is glass.

14. The lighting assembly of claim 11 wherein the body assembly is constructed of a translucent material.

15. The lighting assembly of claim 1 wherein the socket assembly is configured to removable receive a cap assembly of an incandescent bulb assembly.

16. A lighting assembly comprising:
a body assembly configured to allow for the passage of visible light, the body assembly including:
a socket assembly configured to removable receive a cap assembly of a bulb assembly,
a bulb recess configured to receive at least a portion of the bulb assembly, wherein the bulb recess is configured to form a shroud that visually obscures at least a portion of a light emitting portion of the bulb assembly, and
a conductor assembly configured to provide electrical energy to the socket assembly;
a base assembly coupled to the body assembly; and
a cord assembly electrically coupled to the conductor assembly, wherein the cord assembly includes a plug assembly configured to releasably engage an electrical outlet.

17. The lighting assembly of claim 16 wherein the body assembly is constructed of a transparent material.

18. The lighting assembly of claim 17 wherein the transparent material is glass.

19. The lighting assembly of claim 16 wherein the body assembly is constructed of a translucent material.

20. The lighting assembly of claim 1 wherein the socket assembly is configured to removable receive a cap assembly of an incandescent bulb assembly.
